(19) United States
(12) Patent Application Publication
(10) Pub. No.: US 2010/0135899 A1
(43) Pub. Date: Jun. 3, 2010

(54) PROCESS FOR RELEASING HYDROGEN GAS

(76) Inventors: Jizhong Luo, Singapore (SG); Huajun Zhang, Singapore (SG); Jianyi Lin, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/520,431

(22) PCT Filed: Dec. 20, 2006
(86) PCT No.: PCT/SG06/00400

§ 371 Date: Jan. 14, 2010

(51) Int. Cl. C01B 3/02; B01J 19/12

(52) U.S. Cl. 423/648.1; 204/157.52; 204/157.43; 422/186

(57) ABSTRACT

A process for releasing hydrogen gas is disclosed. The process comprises the step of irradiating hydrogen storage particles dispersed within thermal promoter particles under conditions to release said hydrogen from said hydrogen storage particles. A system for implementing the process as well as uses for the hydrogen gas released from the above process are disclosed.

### TECHNICAL FIELD

The present invention generally relates to a process for releasing hydrogen gas and to a system for implementing the process.

### BACKGROUND

Hydrogen storage alloys provide an efficient method of storing hydrogen. Hydrogen is an important source of energy in view of the impending depletion of natural sources of fossil fuels. Hydrogen is an energy carrier that is capable of storing and releasing energy when needed. As the only side product of hydrogen during combustion is water, it is regarded as a clean and environmentally benignant alternative source of energy to fossil fuels. Further, due to the wide abundance of hydrogen in the environment, making up 90% of all matter, hydrogen is regarded as a renewable source of energy.

There are a number of known methods for extracting hydrogen, which include: (i) reforming, during which hydrocarbons react with steam to produce carbon monoxide and hydrogen and wherein the carbon monoxide is subsequently removed; (ii) electrolysis from water; (iii) high temperature thermochemical production from water; and (iv) from organisms that synthesize hydrogen. However, once the hydrogen is obtained, it needs to be stored for its further usage.

Some examples of hydrogen storage systems include liquid hydrogen, compressed hydrogen gas, cryo-adsorption systems and metal hydrides systems.

i) Liquid Hydrogen Storage Systems

Hydrogen exists in the liquid phase at extremely low temperatures of 20K or −253° C. Therefore, a great amount of energy is required to chill and compress the liquid hydrogen into storage tanks. Further, the storage tanks must be strong enough to store the liquid hydrogen under pressure and must be insulated in order to preserve the low temperature of liquid hydrogen. Therefore, this method is expensive due to the need for great amounts of energy and for safe, reinforced storage tanks that meet the above criteria.

ii) Compressed Hydrogen Gas Storage Systems

Hydrogen gas is compressed into high-pressure tanks. High pressure tanks can reach a pressure as high as 10,000 psi (700 bar) and hence, safety of such tanks is a major concern. Moreover, a great amount of energy is required to compress hydrogen gas leading to high costs. Furthermore, the space that the compressed hydrogen gas occupies is usually much more than that occupied by gasoline. As an example, a hydrogen gas storage tank that has the same amount of energy as a traditional gasoline tank will occupy a space about 3,000 times greater than that of the gasoline tank.

iii) Cryoadsorption Systems

Cryoadsorption systems are a special type of graphite storage that is able to adsorb hydrogen. The volume of the gas is first cooled at liquid nitrogen temperature (−196° C.) in order to reduce its volume. A high pressure of about 1000 psi is then applied in order to force the adsorption of hydrogen onto the graphite storage system. However, this method requires the need for extreme temperatures and pressures that can be a safety concern.

iv) Hydrogen Storage Materials

Hydrogen storage materials are capable of absorbing and holding hydrogen to form hydrides. Such hydrides include metal hydrides and complex hydrides. Most metal elements in the periodic table of elements can react with hydrogen to form metal hydride. As an example, such metal hydrides include magnesium hydrides and lithium hydrides. For metal hydrides, they can occur in four different forms such as AB₅ hydrides (e.g., LaNi₅ hydrides), AB hydrides (e.g., FeTi hydrides), A₂B hydrides (e.g., Mg₂Ni hydrides) and AB₂ hydrides (e.g., ZrV₂ hydrides). For metal complex hydrides, hydrogen adsorption can occur in metal alanates, metal boron hydrides, metal amides, and metal imides. Due to the ease of storage and transportation of hydrogen storage materials, hydrogen storage materials are a promising solution for storing hydrogen fuel.

While hydrogen storage materials are promising materials for their hydrogen storage ability, the rate at which these materials release hydrogen gas may be somewhat slow and often requires heating to obtain an adequate release of hydrogen. Furthermore, known processes for releasing hydrogen gas from these hydrogen storage materials are not particularly expeditious and hence, hamper the use of these materials as hydrogen storage materials in applications which require a relatively fast release of hydrogen for use, for example, as a fuel.

There is a need to provide a process to release hydrogen from hydrogen storage materials that overcomes, or at least ameliorates, one or more of the disadvantages described above.

### SUMMARY

According to a first aspect, there is provided a process for releasing hydrogen comprising the step of irradiating hydrogen storage particles dispersed within thermal promoter particles under conditions to release said hydrogen from said hydrogen storage particles.

Advantageously, the thermal promoter particles in an admixture with hydrogen storage particles increases the rate of hydrogen release from the hydrogen storage particles relative to the rate of release without said thermal promoter particles.

In one embodiment, radiation in the microwave range may be used in the irradiation step.

According to a second aspect, there is provided a hydrogen release system comprising:

an enclosed chamber;

a mixture of hydrogen storage particles and thermal promoter particles disposed within said enclosed chamber; and

an irradiation source capable of irradiating the mixture within said enclosed chamber;

wherein in use, said irradiation source irradiates said mixture to release hydrogen from said hydrogen storage particles into said chamber.

In one embodiment, the irradiation source may be a microwave generator.

According to a third aspect, there is provided a vehicle comprising the hydrogen release system of the second aspect.

According to a fourth aspect, there is provided a vehicle which utilizes the step of irradiating hydrogen storage particles dispersed within thermal promoter particles under conditions to release hydrogen from the hydrogen storage particles, for use as a fuel in the vehicle.

According to a fifth aspect, there is provided use of thermal promoter particles in admixture with hydrogen storage particles to promote release of hydrogen while the hydrogen storage particles are being irradiated.

According to a sixth aspect, there is provided a kit of parts for releasing hydrogen, the kit comprising:

hydrogen storage particles;

thermal promoter particles; and

instructions for irradiating a mixture of said hydrogen storage particles and said thermal promoter particles while resident within an enclosed chamber to release hydrogen from said hydrogen storage particles.

According to a seventh aspect, there is provided hydrogen gas generated from a process comprising the step of irradiating hydrogen storage particles dispersed within thermal promoter particles under conditions to release the hydrogen from the hydrogen storage particles.

### DEFINITIONS

The following words and terms used herein shall have the meaning indicated:

The term ‘thermal promoter particles’ refer to any particles which comprise material capable of promoting thermal heating of the hydrogen storage particles while the hydrogen storage particles are being irradiated. The term includes materials that are highly conductive and therefore which reflect the electromagnetic radiation falling on them towards the hydrogen storage particles. Exemplary highly conductive materials include most metals such as Group IIIA metals of the Periodic Table of Elements such as aluminum, Group VIIIB metals of the Periodic Table of Elements such as iron, nickel and cobalt, Group IB metals of the Periodic Table of Elements such as gold, silver and copper, Group VIIB metals of the Periodic Table of Elements such as manganese, Group VIB metals of the Periodic Table of Elements such as chromium, Group IVB metals of the Periodic Table of Elements such as titanium and Group IIB metals of the Periodic Table of Elements such as zinc. Also included are alloys and mixtures thereof. The term also includes thermal conductor materials which may not reflect radiation but may also be capable of promoting thermal conduction of the hydrogen storage particles as these materials undergo heating while being irradiated and which transfer their heat by conduction with the hydrogen storage particles with which they are in contact. An example of a suitable thermal conductor material includes elements from the Group IVA, VA and VIA of the Periodic Table of Elements such as carbon, silicon, phosphor, sulfur and its allotropes. Also included are the complexes and mixtures thereof.

The term ‘hydrogen storage particles’ refer to any particles which comprise material capable of absorbing or desorbing hydrogen. As an example, such hydrogen storage particles include metal hydrides, complex metal hydrides, metal nitrides, metal amides, metal imides, metal alanates, metal boron hydrides and complexes and mixtures thereof. As an example, the constituents of the hydrides are selected from Group IA, Group IIA, Group IIIA, Group VIIIB, Group IIIB, Group IVB, Group VB and Group VA of the Periodic Table of Elements, and mixtures thereof. Some exemplary hydrogen storage particles used are magnesium hydrides, lithium hydrides, lithium imides, lithium amides, lithium nitrides, lithium alanates, lithium boron hydride, sodium imides, sodium amides, sodium nitrides, sodium alanates, sodium boron hydride, magnesium imides, magnesium amides, magnesium nitrides, magnesium alanates, magnesium-nickel-hydrides and mixtures thereof.

The term ‘irradiation’ is to be interpreted broadly to include any electromagnetic radiation according to the Electromagnetic Spectrum. Some examples of electromagnetic radiation include radio waves, microwaves, infrared, ultraviolet, X-rays and gamma rays.

The term ‘microwave’ is to be interpreted broadly to include any electromagnetic waves that have frequencies in the range of about 300 MHz to about 300 GHz. This range can be divided into the ultra-high frequency range of 0.3 to 3 GHz, the super high frequency range of 3 to 30 GHz and the extremely high frequency range of 30 to 300 GHz. The common sources of microwaves, are microwave ovens that emit microwave radiation at a frequency of about 2.45, 0.915, or 5.8 GHz.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### Disclosure of Optional Embodiments

Exemplary, non-limiting embodiments of a process for releasing hydrogen gas will now be disclosed. The process comprises the step of irradiating hydrogen storage particles dispersed within thermal promoter particles under conditions to release the hydrogen from said hydrogen storage particles.

The irradiating step may be carried out using radiation sources such as radio waves, microwaves, infrared, ultraviolet, X-rays and gamma rays. The microwaves may be used as the source of irradiation. The microwaves may be used to produce high temperatures uniformly inside a material as compared to conventional heating means which may result in heating only the external surfaces of a material.

The two main mechanisms of microwave heating are dipolar polarization and conduction mechanism. Dipolar polarization is a process by which heat is generated in polar molecules. When an electromagnetic field is applied, the oscillating nature of the electromagnetic field results in the movement of the polar molecules as they try to align in phase with the field. However, the inter-molecular forces experienced by the polar molecules effectively prevent such alignment, resulting in the random movement of the polar molecules and generating heat. Conduction mechanisms result in the generation of heat due to resistance to an electric current. The oscillating nature of the electromagnetic field causes oscillation of the electrons or ions in a conductor such that an electric current is generated. The internal resistance faced by the electric current results in the generation of heat.

Without being bound by theory, the inventors of the present invention theorizes that some of the selected thermal promoter particles, such as for example, carbon, may aid in the heating and excitation of the hydrogen storage particles at the molecular level such that hydrogen may be released more quickly via thermal conduction mechanism. For example, as carbon does not exhibit any dipole moments, it is theorized that the microwave heating mechanism of the present invention is not via dipolar polarization. Furthermore, the inventors theorizes that materials with high electrical conductivities that have the ability to reflect microwaves also promote heating and excitation of the hydrogen storage particles at the molecular level due to the reflection of the microwaves energy. Exemplary materials include aluminum and iron. However, it should be noted that this is only speculation to explain the phenomena observed by the inventors in the course of undertaking experimental trials. The actual mechanisms for the disclosed thermal promoter particles may be different.

The microwaves may be applied at a power in the range selected from the group consisting of about 30 W to about 180 KW, about 30 W to about 150 KW, about 30 W to about 120 KW, about 30 W to about 100 KW, about 30 W to about 50 KW, about 30 W to about 25 KW, about 30 W to about 15 KW, about 30 W to about 10 KW, about 30 W to about 5 KW, about 30 W to about 2 KW, about 30 W to about 1200 W, about 50 W to about 1200 W, about 100 W to about 1200 W, about 200 W to about 1200 W, about 300 W to about 1200 W, about 400 W to about 1200 W, about 500 W to about 1200 W, about 600 W to about 1200 W, about 700 W to about 1200 W, about 800 W to about 1200 W, about 900 W to about 1200 W, about 1000 W to about 1200 W, about 30 W to about 1100 W, about 30 W to about 100 W, about 30 W to about 80 W, about 30 W to about 60 W, about 30 W to about 40 W, about 40 W to about 120 W, about 60 W to about 120 W, about 80 W to about 120 W, about 100 W to about 120 W, about 70 W to about 100 W and about 50 W to about 70 W.

In one embodiment, the power of the microwaves may be adjusted during said irradiating. Advantageously, by adjusting the power of the microwaves during said irradiating, it is possible to adjust the amount of hydrogen released from the hydrogen storage materials. For example, in some use applications, such as an automobile, a relatively high quantity of hydrogen may be required at start-up of the motor which would require a higher microwave power being imparted to the hydrogen storage materials relative to when the engine is in normal operation.

In one embodiment, if magnesium hydride is used as the hydrogen storage particles, the microwave power is in the range of about 70 W to about 1000 W. In another embodiment, if lithium alanate is used as the hydrogen storage particles, the microwave power used is in the range of about 50 W to about 450 W. In a further embodiment, if a mixture of lithium amide and lithium hydride is used as the hydrogen storage particles, the microwave power used is in the range of about 50 W to about 700 W.

The microwaves may be applied with a frequency in the range selected from the group consisting of about 0.3 GHz to about 300 GHz, about 0.3 GHz to about 200 GHz, about 0.3 GHz to about 100 GHz, about 0.3 GHz to about 50 GHz, about 0.3 GHz to about 10 GHz, about 0.3 GHz to about 5.8 GHz, about 0.3 GHz to about 2.45 GHz, about 0.3 GHz to about 0.915 GHz and about 0.3 GHz to about 0.9 GHz.

The microwaves may be applied in an inert atmosphere, a hydrogen atmosphere or under a partial vacuum. The presence of an inert atmosphere may be created by pumping in an inert gas into an enclosed chamber containing the mixture of thermal promoter particles and hydrogen storage particles. The inert gas may be one selected from the Group VIIIA or Group VA of the Periodic Table of Elements. The inert gas may be one that does not substantially react with the thermal promoter particles, the hydrogen storage particles or the hydrogen gas released. The inert gas may act as a carrier gas to transport the hydrogen released into a storage chamber or to an analyzer to determine the amount of hydrogen released. In one embodiment, the inert gas is argon.

A partial vacuum may be created in the enclosed chamber via connections to a vacuum pump. The vacuum pump may aid in the removal of hydrogen from the enclosed chamber as hydrogen is released from the hydrogen storage particles.

The thermal promoter particles may be mixed with the hydrogen storage particles such that the weight percent of the thermal promoter particles relative to the hydrogen storage particles may be in the range selected from the group consisting of about 0.1 wt % to about 75 wt %, 0.1 wt % to about 70 wt %, 0.1 wt % to about 60 wt %, about 0.1 wt % to about 50 wt %, about 0.1 wt % to about 25 wt %, about 0.1 wt % to about 15 wt %, about 0.1 wt % to about 10 wt %, about 0.1 wt % to about 5 wt %, about 5 wt % to about 20 wt %, about 5 wt % to about 15 wt %, about 5 wt % to about 10 wt %, about 10 wt % to about 25 wt %, about 15 wt % to about 25 wt %, about 20 wt % to about 25 wt % and about 10 wt % to about 20 wt %.

The hydrogen storage particles may be comprised of material selected from the group consisting of metal hydrides, metal nitrides, metal amides, metal imides, metal alanates, metal boron hydride, complex metal hydrides and complexes, mixtures and derivatives thereof.

The metal hydrides may be in the general formula of:

MHₐ

wherein

M is selected from the group consisting of Group IA, Group IIA and Group IIIA of the Periodic Table of Elements; and

a is a number between 1 and 3 to balance the valancy charge.

Exemplary metal hydrides include magnesium hydrides, calcium hydride, lithium hydrides, sodium hydride, potassium hydride, and aluminum hydrides.

The metal of the metal nitrides, metal amides, metal imides, metal boron hydrides and metal alanates may be selected from Group IA and Group IIA of the Periodic Table of Elements. Some examples include, but are not limited to, lithium imides, lithium amides, lithium nitrides, lithium boron hydrides, lithium alanates, sodium imides, sodium amides, sodium boron hydrides, sodium alanates, magnesium imides, magnesium amides, magnesium nitrides, magnesium alanates and mixtures thereof.

In one embodiment, the hydrogen storage particles are a mixture of lithium hydride and lithium amide (LiNH₂).

The elements of the complex metal hydrides may be selected from the group consisting of Group IA, Group IIA, Group IIIA, Group VIIIB, Group IIIB, Group IVB, Group VA and Group VB of the Periodic Table of Elements, and mixtures thereof. The complex metal hydrides may be in the formula of:

AₓMH_{y}

wherein

A is an alkaline metal or an alkaline earth metal;

M is a transition metal or B or Al;

x is a number from 1 to 4; and

y is a number from 2 to 9.

As an example, the complex metal hydrides may be lithium alanates, lithium boron hydrides, sodium alanatess, sodium boron hydride, magnesium-nickel-hydrides, lanthanum-nickel-hydrides, titanium-iron-hydrides or titanium-manganese-hydrides.

It is to be appreciated that other suitable hydrides and hydrogen storage compounds will be apparent to those skilled in the art. Accordingly, the above are in no way to be construed as limiting examples.

The average particle size of the hydrogen storage particles may be in the micrometer range. In one embodiment, the average particle size is less than about 100 μm. In another embodiment, the average particle size is in the range of about 0.1 μm to about 100 μm. It is to be appreciated that if the hydrogen storage particles are a mixture of two or more types of the above mentioned hydrides, the average particle size of each type of hydrides may be the same or may be different.

The hydrogen storage particles may be prepared in a ball milling process such that the average particle size of the hydrogen storage particles falls in the above range.

The thermal promoter particles may be carbon, silicon, phosphor, sulfur or may be a metal selected from the group consisting of Group IIIA, Group VIIIB, Group VIIB, Group VIB, Group IVB, Group IB and Group IIB of the Periodic Table of Elements, and mixtures thereof.

Exemplary metals that may be suitable as the thermal promoter particles include aluminum, copper, silver, gold, iron, nickel, cobalt, manganese; chromium, titanium, zinc and alloys and mixtures thereof. In one embodiment, iron or aluminum is used as the thermal promoter particles.

Aluminum is an example of a material that has a high electrical conductivity such that it reflects most of the microwave energy that falls on it. When aluminum is used as the thermal promoter particles, the aluminum foil may be cut into strips of length in the range of about 1 mm to about 20 mm and width in the range of about 0.5 mm to about 5 mm.

The carbon used may be in the form of graphite.

The average particle size of the thermal promoter particles is in the range selected from the group consisting of less than about 5000 μm, less than about 4000 μm, less than about 3000 μm, less than about 2000 μm, less than about 1000 μm, less than about 500 μm, less than about 200 μm, and less than about 100 μm, about 0.1 μm to about 5000 μm, about 10 μm to about 130 μm, about 10 μm to about 110 μm, about 10 μm to about 90 μm, about 10 μm to about 70 μm, about 10 μm to about 50 μm, about 10 μm to about 30 μm, about 30 μm to about 150 μm, about 50 μm to about 150 μm, about 70 μm to about 150 μm, about 90 μm to about 150 μm, about 110 μm to about 150 μm, about 130 μm to about 150 μm and about 50 μm to about 100 μm.

Exemplary, non-limiting embodiments of a hydrogen release system will now be disclosed. The hydrogen release system comprises an enclosed chamber; a mixture of hydrogen storage particles and thermal promoter particles disposed within the enclosed chamber; and an irradiation source capable of irradiating the mixture within the enclosed chamber, wherein in use, the irradiation source irradiates the mixture to release hydrogen from said hydrogen storage particles into the enclosed chamber.

In one embodiment, the irradiation source is a microwave generator.

In another embodiment, an inert atmosphere or a hydrogen atmosphere or a partial vacuum is introduced in the enclosed chamber. The inert atmosphere may be due to the presence of an inert gas such as argon.

The hydrogen release system mentioned above may be used in a vehicle, stationary power station or portable power device. The vehicle may utilize the step of irradiating hydrogen storage particles dispersed within thermal promoter particles under conditions to release hydrogen from the hydrogen storage particles. The hydrogen released may be employed as a source of energy or fuel for the vehicle. The vehicle may be any device that is used for transportation. Exemplary vehicles include automobiles, motorcycles, ships, trains and aircraft.

Thermal promoter particles may be used in an admixture with hydrogen storage particles to promote release of hydrogen while the hydrogen storage particles are being irradiated.

There is also provided a kit of parts for releasing hydrogen, the kit may comprise an enclosed chamber; a mixture of hydrogen storage particles and thermal promoter particles for disposal within said enclosed chamber in use; an irradiation source capable of irradiating the mixture within said enclosed chamber; and instructions for using said irradiation source to irradiate said mixture while resident within said chamber to release hydrogen from said hydrogen storage particles. The instructions may provide details on the operating parameters of the irradiation process such as power, frequency, pressure or time for the release of hydrogen.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram of an apparatus used in a process according to a disclosed embodiment.

FIG. 2A is a graph showing the hydrogen intensity profile for a mixture of lithium hydride particles, lithium amide particles and graphite carbon under pulsed microwave conditions.

FIG. 2B is a graph showing the hydrogen intensity profile for a mixture of lithium hydride particles, lithium amide particles and graphite carbon under continuous microwave conditions.

FIG. 2C is a graph showing the hydrogen intensity profile for a mixture of lithium hydride particles and lithium amide particles under continuous microwave conditions.

FIG. 3A is a graph showing the hydrogen intensity profile for a mixture of lithium alanate particles and graphite carbon under pulsed microwave conditions.

FIG. 3B is a graph showing the hydrogen intensity profile for a mixture of different weight concentrations of lithium alanate particles and graphite carbon under continuous microwave conditions.

FIG. 3C is a graph showing the hydrogen intensity profile for a mixture of lithium alanate particles and graphite carbon under ramped microwave conditions.

FIG. 3D is a graph showing the hydrogen intensity profile for a sample of lithium alanate particles under continuous microwave conditions.

FIG. 4A is a graph showing the hydrogen intensity profile for a mixture of magnesium hydride particles and graphite carbon under pulsed microwave conditions.

FIG. 4B is a graph showing the hydrogen intensity profile for a mixture of different weight concentrations of magnesium hydride particles and graphite carbon under continuous microwave conditions.

FIG. 4C is a graph showing the hydrogen intensity profile for a mixture of magnesium hydride particles and graphite carbon under different microwave conditions.

FIG. 4D is a graph showing the hydrogen intensity profile for a sample of magnesium hydride particles under continuous microwave conditions.

FIG. 5 is a graph showing the hydrogen intensity profile for a mixture of Mg₂NiH₄ particles and graphite carbon under pulsed microwave conditions.

FIG. 6 is a graph comparing the hydrogen intensity profiles for a mixture of magnesium hydride particles and graphite carbon under different heating methods.

FIG. 7 is a graph comparing the hydrogen intensity profiles for a mixture of lithium hydride particles, lithium amide particles and graphite carbon under different heating methods.

FIG. 8 is a graph showing the hydrogen intensity profiles of a mixture of lithium hydride particles with different types of thermal promoter particles under the same microwave conditions.

FIG. 9 is a graph showing hydrogen intensity profiles of a mixture of MgH₂+Ni particles under different particle sizes: (A) MgH₂+Ni without ball milling; (B) MgH₂+Ni with ball milling; and (C) MgH₂+Ni with ball milling+C (20%).

FIG. 10 is a graph showing hydrogen intensity profiles of a mixture of LiNH₂-2LiH particles with graphite carbon of different particle sizes: (A) 56 μm graphite; (B) 150 μm graphite; and (C) 250 μm graphite.

### BRIEF DESCRIPTION OF TABLES

Table 1 shows the peak values of the hydrogen intensity for different types of hydrogen storage particles under various microwave conditions as well as the temperature of the particles as obtained from the Temperature Programmed Desorption method.

Table 2 shows the temperature of the different types of hydrogen storage particles obtained under various microwave conditions.

Table 3 shows the peak areas and energy input values of a mixture of magnesium hydride particles and graphite carbon under different heating methods.

Table 4 shows the peak areas and energy input values of a mixture of lithium hydride particles, lithium amide particles and graphite carbon under different heating methods.

### EXAMPLES

Non-limiting examples of the invention and comparative examples will be further described in greater detail by reference to specific Examples, which should not be construed as in any way limiting the scope of the invention.

### Preparation of Test Apparatus

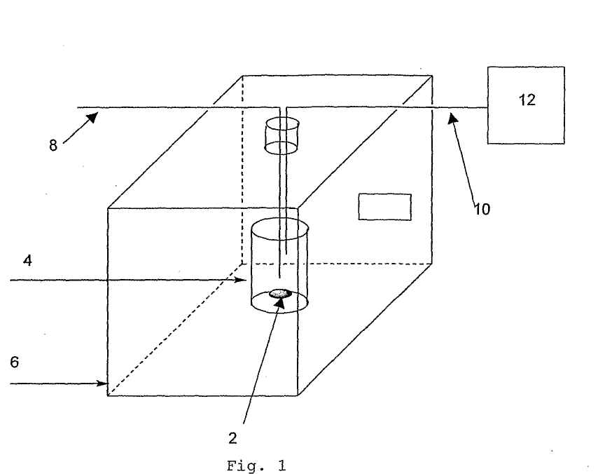

Referring now to FIG. 1, there is shown a set-up of the apparatus used in a process of releasing hydrogen gas from hydrogen storage materials. An admixture 2 of hydrogen storage particles and thermal promoter particles was placed in a reactor 4 having an enclosed cylindrical chamber having a diameter of 4 am and a height of 12 cm. The cylindrical chamber was made from TEFLON™ from E. I. DuPont Corporation, Delaware, United States of America. TEFLON™ is polytetrafluoroethylene (PTFE) and allows microwaves to pass through the reactor 4 to the admixture 2. The reactor 4 containing the admixture 2 was placed in a microwave generator 6. The frequency of the microwaves emitted was 2.45 GHz. Argon was used as a carrier gas and was introduced at a rate of 50 ml/min into the reactor 4 via a gas inlet conduit 8 through the microwave generator 6 and reactor 4. The pressure of the apparatus was kept at 1 bar, or around atmospheric pressure. A gas outlet conduit 10 protrudes from the reactor 4 through the microwave generator 6 to a mass spectrometry analyzer 12 for monitoring the release of hydrogen gas from the reactor 4. A thermometer 14 was disposed on the wall of the microwave generator 6 to measure the temperature.

### Example 1

Hydrogen Storage Particles: LiNH₂-2LiH
Thermal Promoter: Graphite Carbon
Microwave Power: 70 W (intervals)

Lithium hydride (LiH) was obtained from Sigma-Aldrich with 95% purity, lithium amide (LiNH₂) was obtained from Sigma-Aldrich with 95% purity and graphite carbon rod with 99% purity was obtained from Sigma-Aldrich. The graphite carbon rod was crushed in a stainless steel crucible and sieved by Retsch test sieve to 250 μm, 150 μm and 56 μm, respectively.

The LiH and LiNH₂ particles were ball milled such that the average particle size of the LiH and LiNH₂ particles was less than about 1.0 μm.

4.6 g of LiNH₂ and 3.2 g of LiH were loaded into a stainless steel jar inside a glovebox (MBraun master 130) filled with purified Ar (H₂O<1 PPM, O₂<1 PPM). Then, the jar was put on planetary ball mill (Retsch PM400) at 300 rpm for 10 hours. 1.0 g of the mixture of LiNH₂-2LiH and 0.25 g of graphite carbon particles (150 μm) was added into the microwave reactor. The wt % of graphite carbon relative to the above mixture was about 20 wt %. The resultant mixture was placed in the reactor (4) of FIG. 1. Ar gas, which was controlled using a mass flow meter, was set at a flow rate of 50 ml/min. Mass spectrometer (Omnistar) was switched on simultaneously to measure the outlet gas. The microwave generator (6) (Milestone Labstation) was configured to pulse the microwaves emitted. Here, the microwave power was set at 70 W for five minutes intervals and at 0 W for all other times. The reaction was carried out for 60 minutes.

It is believed that the following reactions occurred during the hydrogen release:

LiNH₂+LiH [symbol] Li₂NH+H₂ (1)

Li₂NH+LiH+ [symbol] Li₃N+H₂ (2)

In the first reaction, 6.3˜6.4 wt % of hydrogen was released at a temperature of 250° C. In the second reaction, 5.4 wt % of hydrogen was released at a temperature of 450° C. Theoretically, 6.5 wt % and 5.4 wt % of hydrogen release can be obtained according to equations (1) and (2) respectively, and hence, it will be appreciated that the results of this experiment indicate that practically all of the hydrogen stored on the hydrogen storage materials was released. Due to the impurities such as LiOH and Li₂O presenting in the materials, the results are a lower than the theoretical.

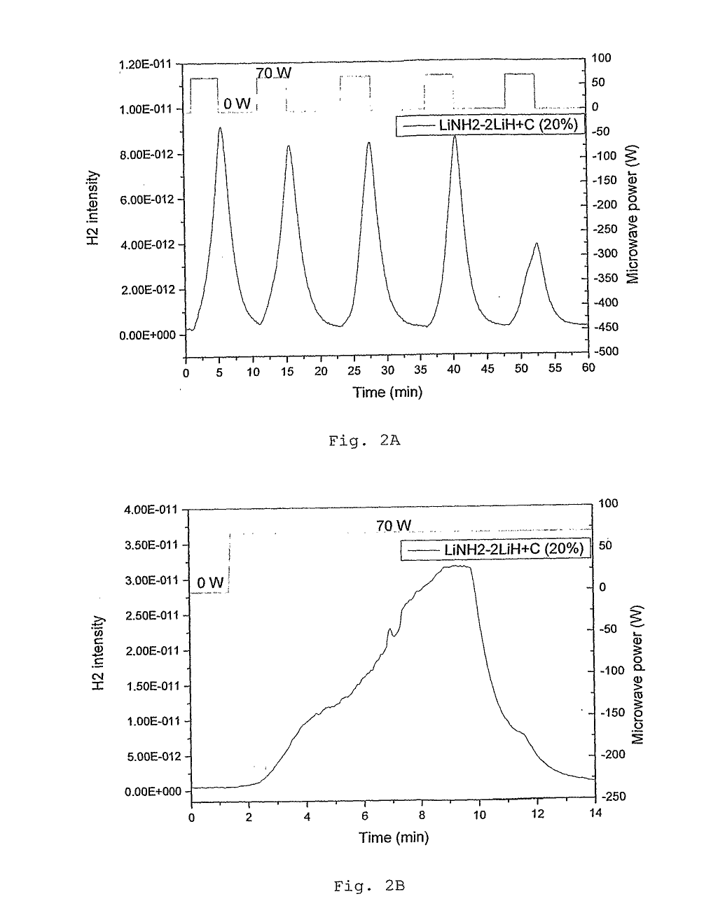

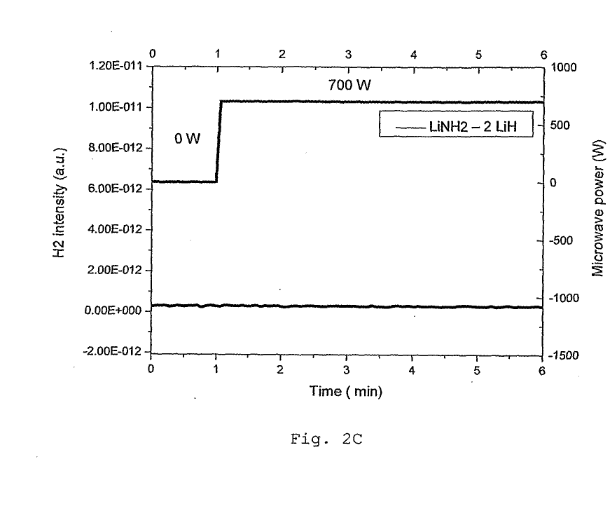

The results of this example are shown in FIG. 2A. It can be seen that hydrogen intensity increases, which indicates the hydrogen release, promptly once the microwave generator was switched on. The hydrogen intensity gradually increases with increase of heating time. When the microwave was turned off (that is, at 0 W), the intensity of the hydrogen signal decreased immediately. This showed that the hydrogen release process was weakened or was terminated when the microwave was switched off. This process can be repeated with good reproducibility. Hence, the data shown in FIG. 2A clearly shows that the application of the microwave to a mixture of metal hydrides and graphite resulted in the rapid and controllable release of hydrogen.

The surface temperature of the hydrogen storage materials was about 40-50° C. indicating that extreme temperatures are not required to promptly release hydrogen gas.

### Example 2

Hydrogen Storage Particles: LiNH₂-2LiH
Thermal Promoter: Graphite Carbon
Microwave Power: 70 W (continuous)

The hydrogen storage particles (LiH and LiNH₂) and thermal promoter particles (graphite carbon) used in this example are the same as those in example 1. However, in this example, the microwave generator was switched on continuously at 70 W instead of at intervals.

The results of this example are shown in FIG. 2B. Similarly, the hydrogen signal appeared immediately once the microwave was switched on. Hydrogen was released continuously as the heating time progressed. Under these conditions, the inflexion point appeared around 10 minutes. After this, the hydrogen intensity decreased gradually such that at 14 minutes, the hydrogen intensity was back at the base line due to the hydrogen being exhausted from the mixture of LiH and LiNH₂. The remaining material was weighted and the result showed that 4.9 wt % of hydrogen was released from the mixture of LiH and LiNH₂. The data of FIG. 2B demonstrates that hydrogen can be rapidly and controllably released in the disclosed process. Again, the surface temperature of the hydrogen storage materials was about 40-50° C. indicating that extreme temperatures are not required to promptly release hydrogen gas.

### Example 3

Hydrogen Storage Particles: LiAlH₄
Thermal Promoter: Graphite Carbon
Microwave Power: 50 W (intervals)

Lithium alanate (LiAlH₄) powder was obtained from Sigma-Aldrich with 95% purity. The lithium alanate was used without further treatment. Graphite carbon rod with 99% purity was obtained from Sigma-Aldrich. The graphite carbon rod was crushed in a stainless steel crucible and sieved by Retsch test sieve to 250 μm, 150 μm and 56 μm, respectively

1.0 g of LiAlH₄ was mixed with 0.25 g of graphite carbon (150 μm) such that the wt % of graphite carbon relative to that of LiAlH₄ was about 20 wt %. The resultant mixture was placed in the reactor (4) of FIG. 1. The microwave generator (6) (Milestone Labstation) was configured to pulse the microwaves emitted. Here, the microwave power was set at 50 W for four minutes intervals and at 0 W for all other times. The reaction was carried out for 70 minutes.

It is believed that the following reactions occurred during the hydrogen release:

LiAlH₄→LiAl+2H₂

3LiAlH₄→Li₃AlH₆+2Al+3H₂

Li₃AlH₆→3LiH+Al+3/2H₂

3LiH+3Al→3LiAl+3/2H₂

In the first reaction, 10.5 wt % of hydrogen was released. In the second reaction, 5.3 wt % of hydrogen was released at a temperature in the range of 150° C. to 175° C. In the third reaction, 2.6 wt % of hydrogen was released at a temperature in the range of 180° C. to 225° C. In the fourth reaction, 2.6 wt % of hydrogen was released at a temperature greater than 400° C.

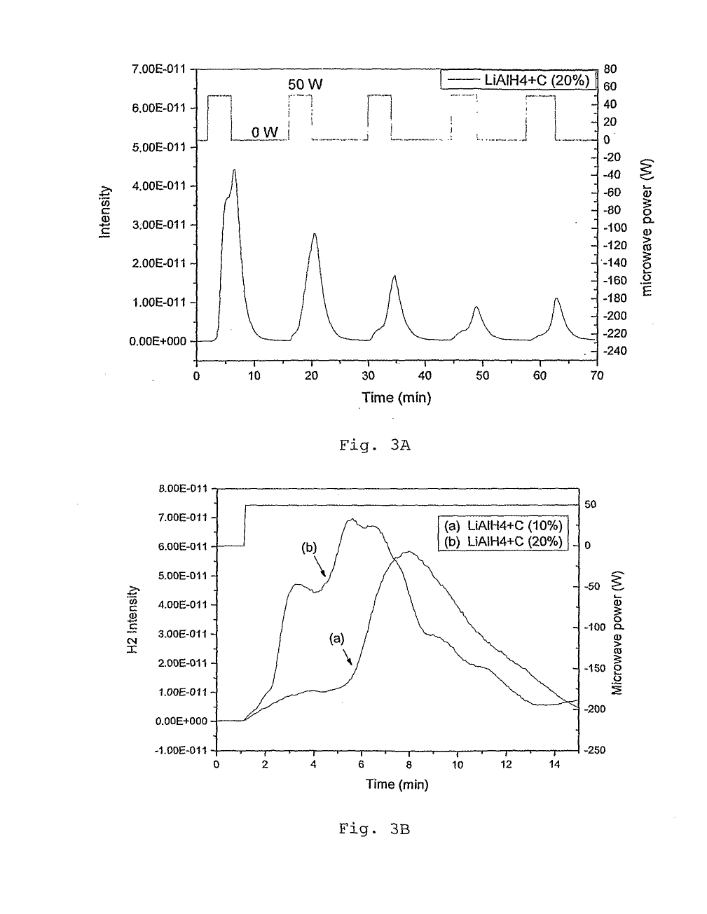

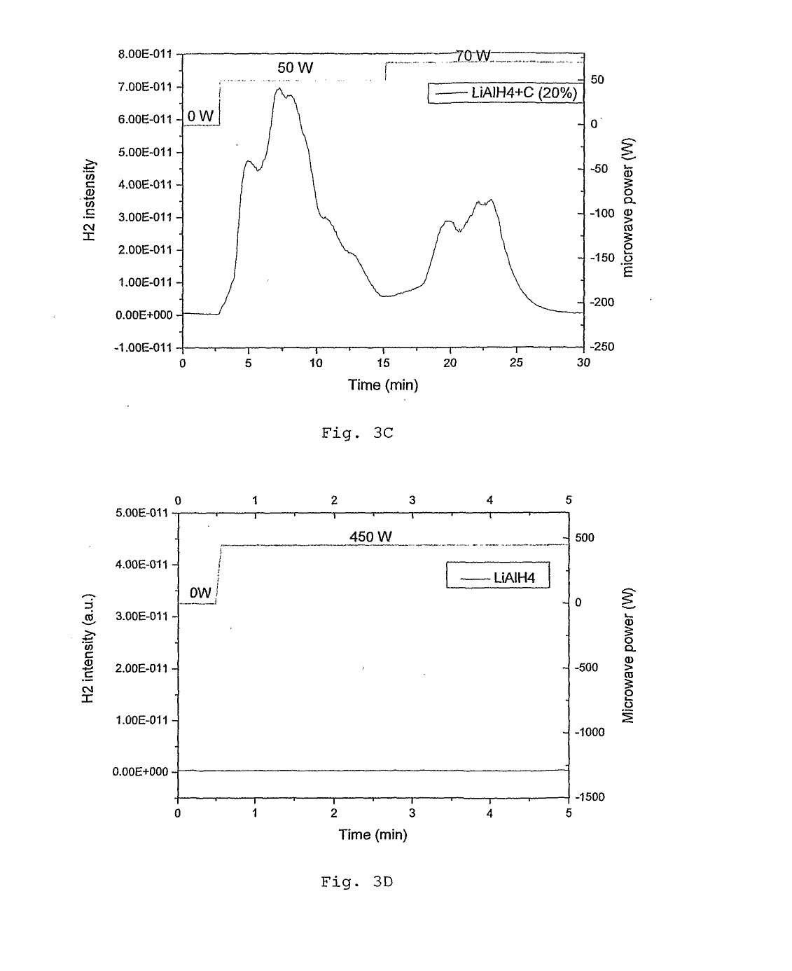

The results of this example are shown in FIG. 3A. It can be seen that hydrogen was rapidly released once the microwave generator was switched on. The hydrogen intensity increases with the increase of irradiation time, indicating that more hydrogen was released. When the microwave was turned off (that is, at 0 W) at 4 minutes, the intensity of the hydrogen signal rapidly decreased. This shows that the hydrogen release process was weakened or was terminated when the microwave was switched off. Hence, the data shown in FIG. 3A clearly demonstrates that the application of the microwave to a mixture of LiAlH₄ and graphite resulted in the rapid and controllable release of hydrogen.

Again, the surface temperature of the hydrogen storage materials was about 40-50° C. indicating that extreme temperatures are not required to promptly release hydrogen gas.

### Example 4

Hydrogen Storage Particles: LiAlH₄
Thermal Promoter: Graphite Carbon (10 wt % and 20 wt %)
Microwave Power: 50 W (Continuous)

In this example, LiAlH₄ and graphite carbon were obtained from the same suppliers as in example 3. This example is designed to show the difference in the hydrogen intensity profile when different wt % of graphite carbon was used in the admixture with the LiAlH₄.

In the first sample, 1.0 g of LiAlH₄ was mixed with 0.11 g of graphite carbon such that the wt % of graphite carbon relative to LiAlH₄ was about 10 wt %.

In the second sample, 1.0 g of LiAlH₄ was mixed with 0.25 g of graphite carbon such that the wt % of graphite carbon relative to LiAlH₄ was about 20 wt %.

The microwave generator was switched on continuously at 50 W for around 14 minutes.

The results of this example are shown in FIG. 3B. It can be seen that the ratio of graphite carbon to LiAlH₄ has a great influence on the release of hydrogen. The higher the concentration of graphite used in the admixture, the faster the rate of hydrogen release. For the admixture with 20 wt % of graphite carbon, the hydrogen release was faster than that of the admixture with 10 wt % of graphite carbon. The hydrogen intensity of the admixture with 20 wt % graphite carbon peaked at around 5.5 minutes as compared to the admixture with 10 wt % graphite carbon which peaked at around 8 minutes. Therefore, a higher concentration of graphite carbon particles may be desired in applications wherein the prompt release of hydrogen gas is required. For both admixtures, 4.5 wt % of hydrogen gas was released.

The surface temperature of the hydrogen storage materials was about 40-50° C. indicating that extreme temperatures are not required to promptly release hydrogen gas.

### Example 5

Hydrogen Storage Particles: LiAlH₄
Thermal Promoter: Graphite Carbon
Microwave Power: 50 W and 70 W (Ramp)

In this example, LiAlH₄ was obtained from the same supplier as in example 3. This example is designed to show the effects on hydrogen gas release when the microwave power is ramped from 50 W to 70 W during the course of the experiment.

The microwave generator was switched on at 50 W for around 12.5 minutes and then the power was increased to 70 W for the next 15 minutes. This example was carried out for a total of 30 minutes.

The results of this example are shown in FIG. 3C. By ramping the microwave power from 50 W to 70 W, a second stage of hydrogen release could be induced. It is to be noted that in the first stage of this experiment (ie when the power is at 50 W), the hydrogen gas release profile has the same characteristic as that in FIG. 3B, indicating high reproducibility. Here, 8.0 wt % of hydrogen gas was released. Therefore, by ramping up the microwave power, more hydrogen gas could be released.

Again, the surface temperature of the hydrogen storage materials was about 40-50° C. indicating that extreme temperatures are not required to promptly release hydrogen gas.

### Example 6

Hydrogen Storage Particles: Magnesium Hydride
Thermal Promoter: Graphite Carbon
Microwave Power: 50 W (Intervals)

Magnesium hydride (MgH₂) was obtained from Alfa-Aesar with 95% purity. Magnesium hydride was used without further treatment. Graphite carbon rod with 99% purity was obtained from Sigma-Aldrich. The graphite carbon rod was crushed in a stainless steel crucible and sieved by Retsch test sieve to 250 μm, 150 μm and 56 μm, respectively.

1.0 g of MgH₂ was mixed with 0.25 g of graphite carbon (150 μm) such that the wt % of graphite carbon relative to that of MgH₂ was about 20 wt %. The resultant mixture was placed in the reactor (4) of FIG. 1. The microwave generator (6) (Milestone Labstation) was configured to pulse the microwaves emitted. Here, the microwave power was set at 50 W at intervals of about four to five minutes and at 0 W for all other times. The reaction was carried out for 50 minutes.

It is believed that the following reaction occurred during the hydrogen release:

MgH₂→Mg+H₂

In this reaction, 7.6 wt % of hydrogen was released at 350° C. The theoretical amount of hydrogen release is also 7.6 wt %, hence, the hydrogen storage materials released all of their hydrogen in this experiment.

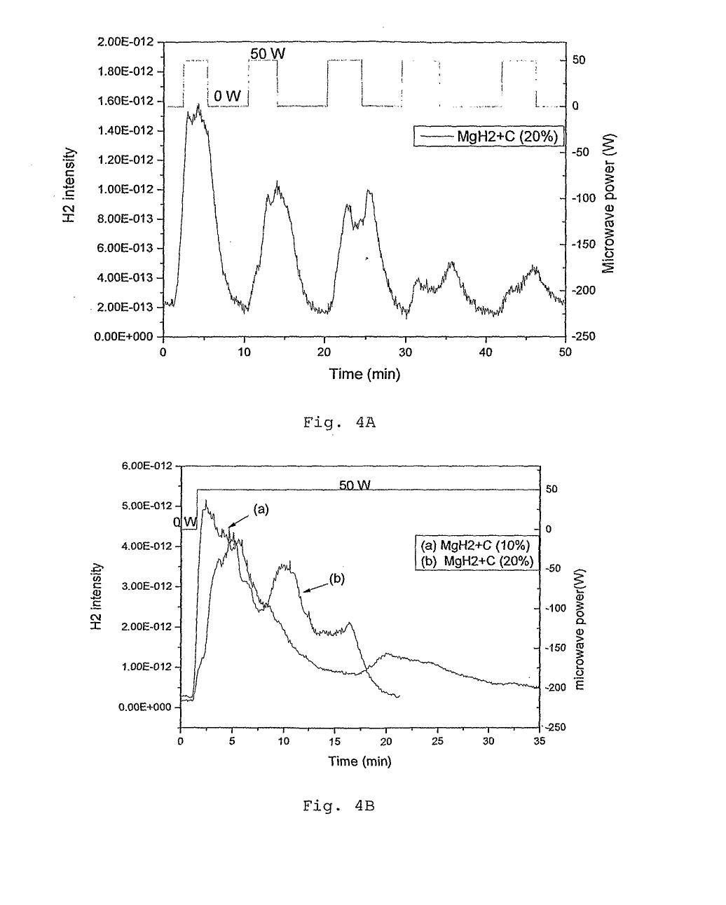

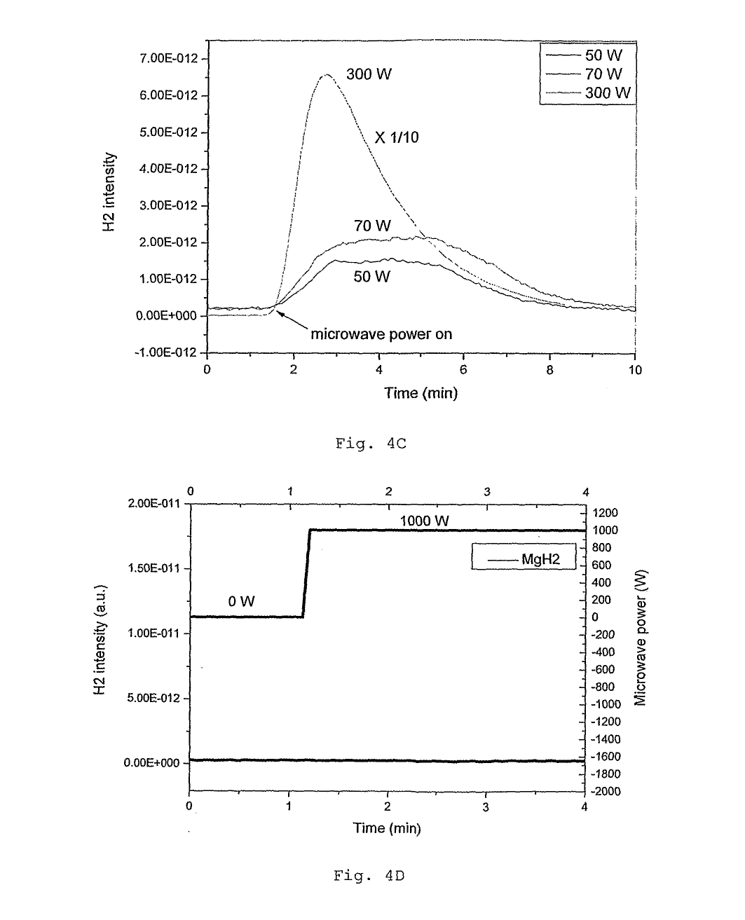

The results of this example are shown in FIG. 4A. It can be seen that hydrogen was rapidly released once the microwave generator is switched on. The hydrogen intensity increases with the increase of irradiation time, indicating more hydrogen is released from the mixture. When the microwave was turned off (that is, at 0 W), the intensity of the hydrogen signal rapidly decreased. This shows that the hydrogen release process was weakened, or was terminated, when the microwave was switched off. Hence, the data shown in FIG. 4A clearly shows that the application of the microwave to a mixture of MgH₂ and graphite resulted in the rapid and controllable release of hydrogen.

The surface temperature of the hydrogen storage materials was about 40-50° C. indicating that extreme temperatures are not required to promptly release hydrogen gas.

Further, it can be seen from FIG. 4A that there is a gradual decrease in the peak values of the hydrogen intensity over the subsequent intervals when the microwave power was switched on. This could be due to the depletion of MgH₂ as the MgH₂ dissociated to form Mg and H₂.

### Example 7

Hydrogen Storage Particles: MgH₂
Thermal Promoter: Graphite Carbon (10 wt % and 20 wt %)
Microwave Power: 50 W (Continuous)

In this example, MgH₂ and graphite carbon were obtained from the same supplier as in example 6. This example is designed to show the difference in the hydrogen intensity profile when different wt % of graphite carbon was used in the admixture with MgH₂.

In the first sample, 1.0 g of MgH₂ was mixed with 0.11 g of graphite carbon such that the wt % of graphite carbon relative to MgH₂ was about 10 wt %.

In the second sample, 1.0 g of MgH₂ was mixed with 0.25 g of graphite carbon such that the wt % of graphite carbon relative to MgH₂ was about 20 wt %.

The microwave generator was switched on continuously at 50 W for around 35 minutes.

The results of this example are shown in FIG. 4B. It can be seen that the ratio of graphite carbon to MgH₂ has a great influence on the release of hydrogen. The higher the concentration of graphite used in the admixture, the faster the rate of hydrogen release. For the admixture with 20 wt % of graphite carbon, the hydrogen release was faster than that of the admixture with 10 wt % of graphite carbon. The hydrogen intensity of the admixture with 20 wt % graphite carbon peaked at around 2.5 minutes as compared to the admixture with 10 wt % graphite carbon which peaked at around 4.5 minutes. Therefore, a higher concentration of graphite carbon particles may be desired in applications wherein the prompt release of hydrogen gas is required. 3.0 wt % of hydrogen was released for both samples.

The surface temperature of the hydrogen storage materials was about 40-50° C. indicating that extreme temperatures are not required to promptly release hydrogen gas.

### Example 8

Hydrogen Storage Particles: MgH₂
Thermal Promoter: Graphite Carbon
Microwave Power: 50 W, 70 W and 300 W

In this example, MgH₂ was obtained from the same supplier as in example 6. This example is designed to show the differences in the hydrogen intensity profile under various microwave power conditions

1.0 g of MgH₂ was mixed with 0.25 g of graphite carbon such that the wt % of graphite carbon relative to that of MgH₂ was about 20 wt %. Three samples of the above admixture were used.

The microwave generator was switched on continuously at 50 W, 70 W and 300 W. The reaction time was set to 8 to 10 minutes.

The results of this example are shown in FIG. 4C. It can be seen that the microwave power has a great influence on the hydrogen intensity profile. The higher the microwave power, the faster the rate of hydrogen release and the greater the amount of hydrogen gas released.

The surface temperature of the hydrogen storage materials was about 40-50° C. indicating that extreme temperatures are not required to promptly release hydrogen gas.

### Example 9

Hydrogen Storage Particles: Mg₂NiH₄
Thermal Promoter: Graphite Carbon
Microwave Power: 70 W (intervals)

Mg₂NiH₄ was prepared by ball milling of MgH₂ and metal nickel particles. The MgH₂ was obtained from Alfa-Aesar with 95% purity. Metal Nickel was obtained from Alfa-Aesar with 99% purity. 5.2 g of MgH₂ and 5.8 g of Ni were loaded into a stainless steel jar inside a glovebox (MBraun master 130) filled with purified Ar (H₂O<1 PPM, O₂<1 PPM). Then, the jar was put on planetary ball mill (Retsch PM400) at 300 rpm for 10 hours. The final particle size is about 1 μm. Graphite carbon rod with 99% purity was obtained from Sigma-Aldrich. The graphite carbon rod was crushed in a stainless steel crucible and sieved by Retsch test sieve to 250 μm, 150 μm and 56 μm, respectively.

1.0 g of Mg₂NiH₄ was mixed with 0.25 g of graphite carbon (150 μm) such that the wt % of graphite carbon relative to that of Mg₂NiH₄ was about 20 wt %. The resultant mixture was placed in the reactor (4) of FIG. 1. The microwave generator (6) (Milestone Labstation) was configured to pulse the microwaves emitted. Here, the microwave power was set at 70 W at intervals of about five minutes and at 0 W for all other times. The reaction was carried out for 60 minutes.

It is believed that the following reaction occurred during the hydrogen release:

Mg₂NiH₄→Mg₂Ni+2H₂

In this reaction, 3.7 wt % of hydrogen was released at 250° C. The theoretical amount of hydrogen release is also 3.7 wt %, hence, the hydrogen storage materials released all of their hydrogen in this experiment.

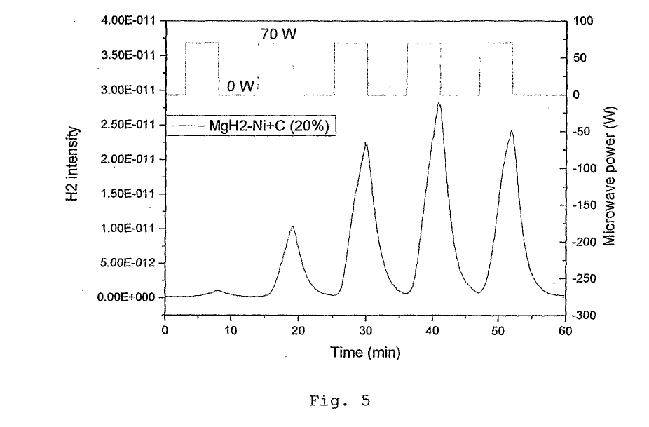

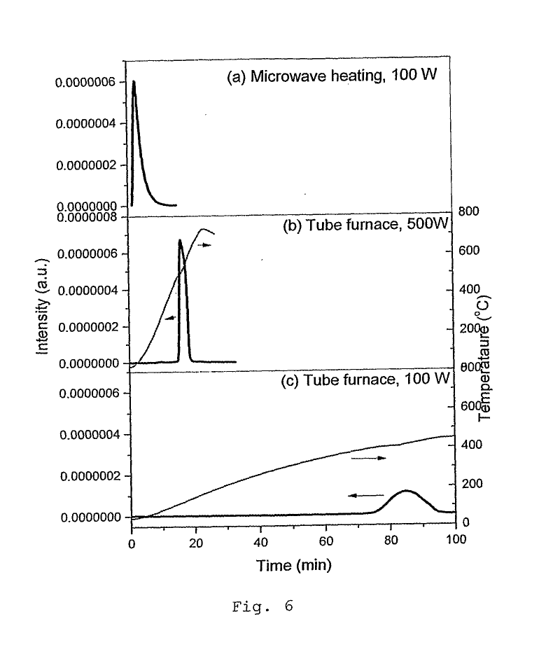

The results of this example are shown in FIG. 5. It can be seen that a lag period was required for the release of hydrogen as no hydrogen gas was released during the first interval of microwave heating. Further, the peak values of the hydrogen intensity increased over the subsequent intervals indicating that a time period is required before optimal release of hydrogen gas.

After the ball milling, the Mg₂NiH₄ was still in an amorphous state. Extra treatment such as calcination is normally required for the crystallization of Mg₂NiH₄. The lag period is also a pre-active process.

### Summary of Results for Examples 1-9

A summary of the hydrogen intensity values of the above examples can be seen in Tables 1 and 2 below.

TABLE 1

| | | | | TPD temperature |
|---|---|---|---|---|
| | 50 W | 70 W | 300 W | (° C.) |
| LiAlH₄ | 2.0E−11 | 6.0E−11 | — | 168, 241, 443 |
| LiNH₂ + 2LiH | | 7.0E−12 | | 224 |
| MgH₂ | 1.4E−12 | 2.0E−12 | 4.0E−11 | 334 |
| Mg₂NiH₄ | — | 2.5E−12 | | 250, 331 |

TABLE 2

| | 30 W | 40 W | 50 W | 70 W |
|---|---|---|---|---|
| LiAlH₄ + C (20%) (° C.) | 87 | 104 | 107 | 117 |
| MgH₂ + C (20%) (° C.) | 28 | 63 | 139 | — |

The Temperature Programmed Desorption (TPD) temperature is the temperature at which hydrogen is released from the hydrogen storage particles. The TPD temperatures indicate the temperatures at which hydrogen is released during conventional heating.

As shown in Table 1, the hydrogen intensity decreased according to LiAlH₄>LiNH₂+2LiH>Mg₂NiH₄>MgH₂. This is the same order as the first hydrogen desorption temperature. Therefore, there is good correlation between the microwave heating and traditional conduction heating.

In Table 2, the surface temperatures of various hydrogen storage particles under different microwave power conditions are shown. For both samples, there was an increase in the surface temperature with an increase in the microwave power. It is to be noted that these temperature values are much lower than the TPD temperatures of Table 1. Hence, this may indicate that microwave resulted in heating up of the internal regions of the hydrogen storage particles.

### Example 10

Hydrogen Storage Particles: MgH₂
Thermal Promoter: graphite carbon
Microwave Power: 100 W (continuous)

MgH₂ particles and graphite carbon were obtained and prepared as disclosed in Example 6.

0.5 g of MgH₂ was mixed with 0.125 g of graphite carbon such that the wt % of graphite carbon relative to that of MgH₂ was about 20 wt %. The resultant mixture was placed in the reactor (4) of FIG. 1. The microwave generator (6) (Milestone Labstation) was set to continuously generate microwaves at a microwave power of 100 W for about 15 minutes.

The results of this example are shown in FIG. 6. Table 3 shows the Peak area and energy input for the microwave heating and FIG. 6A and tube furnace heating (FIGS. 6B,6C).

TABLE 3

| | Microwave heating, | Tube furnace, | Tube furnace |
|---|---|---|---|
| | 100 W | 100 W | 500 W |
| Peak area (×E−6) | 1.42 | 1.46 | 1.64 |
| Eᵢₙₚᵤₜ (KJ)* | 90 | 582 | 510 |

*Eᵢₙₚᵤₜ (kJ) = P (W) * t(s)/1000

As seen in FIG. 6, the hydrogen came out almost immediately once the microwave was switched on. It can also be seen from FIG. 6 that for conventional heating (tube furnace), the higher the power, the more efficient for the hydrogen release. As can be see in Table 3, the peak area was almost the same for the tube heating, but the hydrogen release completes within 25 minutes for 500 W heating power (Tube furnace), while it is 100 minutes for 100 W heating power (Tube furnace). The microwave definitely shows the most promising results for hydrogen release in that the release of hydrogen completed within about 15 minutes by this method.

Regarding to the energy efficiency, microwave heating is about 5 to about 6 times more efficient than conventional heating.

### Example 11

Hydrogen Storage Particles: LiH, LiNH₂
Thermal Promoter: graphite carbon
Microwave Power: 100 W (continuous)

0.50 g of the mixture of LiNH₂ and LiH which was prepared as disclosures Example 1 was mixed with 0.125 g of graphite carbon such that the wt % of graphite carbon relative to the above mixture is about 20 wt %. The resultant mixture was placed in the reactor (4) of FIG. 1. The microwave generator (6) (Milestone Labstation) was set to continuously generate microwaves at a microwave power of 100 W for about 20 minutes.

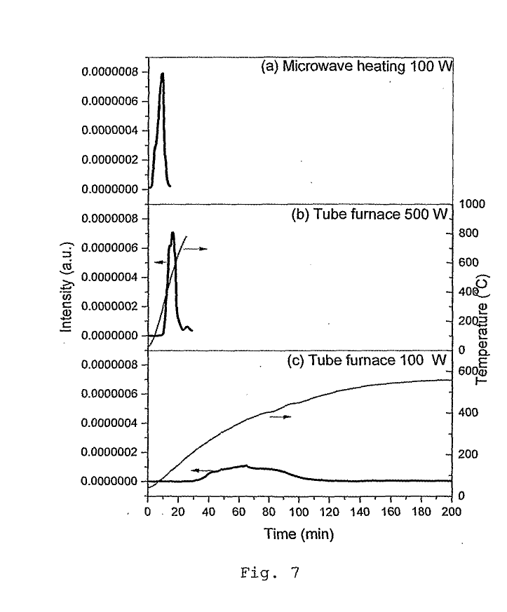

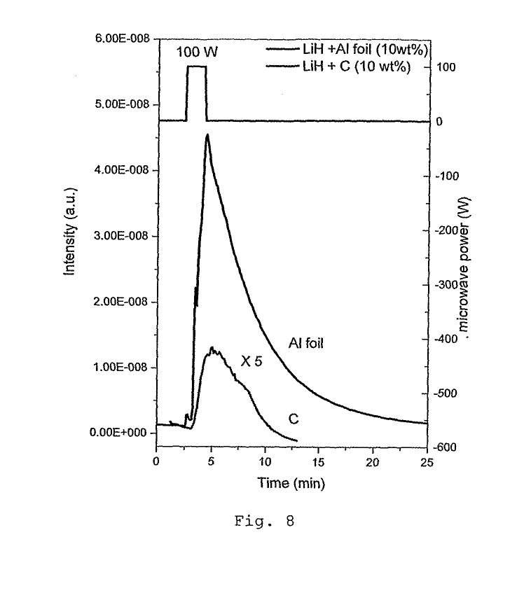

The results of this example are shown in FIG. 7. As seen, the hydrogen came out almost immediately once the microwave was switched on.

TABLE 4

| | Microwave heating, | Tube furnace, | Tube furnace |
|---|---|---|---|
| | 100 W | 100 W | 500 W |
| Peak area (×E−6) | 5.62 | 5.77 | 6.08 |
| Eᵢₙₚᵤₜ (kJ)* | 87 | 780 | 750 |

*Eᵢₙₚᵤₜ (kJ) = P (W) * t(s)/1000

Like in Example 10, it can be seen from FIG. 7 that for conventional heating (tube furnace), the higher the power, the more efficient for the hydrogen release. As can be see in Table 4, the peak area was almost the same for the tube heating, but the hydrogen release completes within 25 minutes for 500 W heating power (Tube furnace), while it is 100 minutes for 100 W heating power (Tube furnace). The microwave definitely shows the most promising results for hydrogen release in that the release of hydrogen completed within about 15 minutes by this method.

Again, in this example, microwave heating was about 8 to about 9 times more efficient than conventional heating.

### Example 12

Hydrogen Storage Particles: LiH
Thermal Promoter: Graphite Carbon and Aluminum Foil
Microwave Power: 100 W (interval)

Lithium hydride was obtained prepared according to the disclosures of Example 1. This example is designed to show (i) microwave irradiation is capable to release hydrogen from very stable metal hydride such as LiH, on which, hydrogen release need temperature as high as 650° C.; (ii) the effects of different types of thermal promoter particles on the hydrogen release profile.

1.0 g of LiH was mixed with 0.11 g of graphite carbon such that the wt % of graphite carbon relative to the above mixture was about 10 wt %.

1.0 g of LiH was mixed with 0.11 g of strips of aluminum foil such that the wt % of aluminum foil relative to the above mixture was about 10 wt %. The aluminum foils had an average length of about 5 mm and an average width of about 2 mm.

The resultant mixture was placed in the reactor (4) of FIG. 1. The microwave generator (6) (Milestone Labstation) was pulsed once at 100 W for about two minutes.

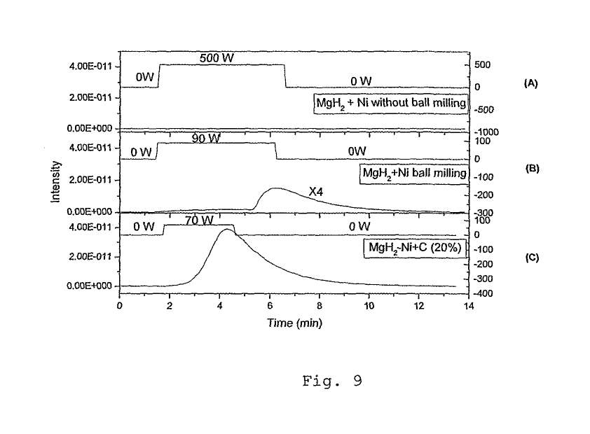

The results of this experiment are shown in FIG. 8. It can be seen that hydrogen intensity promptly increases, which indicates the hydrogen release, once the microwave generator was switched on. The hydrogen intensity gradually increases with increase of heating time. When the microwave was turned off (that is, at 0 W), the intensity of the hydrogen signal decreased immediately. This showed that the hydrogen release process was weakened or was terminated when the microwave was switched off.

With the same concentration, the use of aluminum foil as the thermal promoter particle enhanced the rate of hydrogen gas released from the LiH particles as compared to the use of graphite carbon as the thermal promoter particles. This showed that the aluminum foil aided in the achievement of the hydrogen release more rapidly as compared to graphite carbon.

LiH is known in the art to have a high hydrogen release temperature of around 696° C. as determined via TPD experiments. LiH is seldom considered to be a feasible source of hydrogen due to the high temperature needed to release the hydrogen even though it has a high hydrogen storage capacity of 12.5 wt %. Advantageously, the use of aluminum foil as thermal promoter particles may promote the release of hydrogen from LiH under moderate microwave conditions of around 100 W.

Therefore, the use of thermal promoter particles under microwave conditions may be used to release hydrogen from hydrogen storage particles that may require extreme conditions under conventional means.

### Effect of Particle Size

### Example 13

Hydrogen Storage Particles: MgH₂+Ni
Sample (A)=500 W (pulse),
   thermal Promoter: none
Sample (B)=90 W (pulse),
   thermal Promoter: none
Sample (C)=70 W (pulse),
   thermal Promoter: graphite carbon

The MgH₂ was obtained from Alfa-Aesar with 95% purity. Magnesium hydride was used without further treatment. Metal Nickel was obtained from Alfa-Aesar with 99% purity. Nickel was used without further treatment.

In (A), 0.47 g of MgH₂ and 0.53 g of Ni were simply mixed in a container and were not subjected to ball milling.

In (B), 5.2 g of MgH₂ and 5.8 g of Ni were loaded into a stainless steel jar inside a glovebox (MBraun master 130) filled with purified Ar (H₂O<1 PPM, O₂<1 PPM). Then, the jar was put on planetary ball mill (Retsch PM400) at 300 rpm for 10 hours. The final particle size was about 1 μm. 1.0 g of the admixture was used.

In (C), graphite carbon rod with 99% purity was obtained from Sigma-Aldrich. The graphite carbon rod was crushed in a stainless steel crucible and sieved by Retsch test sieve to 250 μm, 150 μm and 56 μm, respectively. 1.0 g of Mg₂NiH₄ was mixed with 0.25 g of graphite carbon such that the wt % of graphite carbon relative to that of Mg₂NiH₄ was about 20 wt %.

The resultant mixtures (A), (B) and (C) were placed in the reactor (4) of FIG. 1. The microwave generator (6) (Milestone Labstation) was configured to pulse the microwaves emitted. Here, the microwave power was set for (A), (B) and (C) was respectively as follows:

(A): 500 W for about 5 minutes;

(B): 90 W for about 5 minutes; and

(C): 70 W for about 2.5 minutes.

The release of hydrogen was recorded by mass spectrometer (12) of FIG. 1 and the results can be seen in FIG. 9. It will be noted from FIG. 9A that without ball milling, no hydrogen was released from the MgH₂+Ni sample (A) even though the microwave power was as high as 500 W. However, as will be noted from FIG. 9B, after the ball milling, trace amount of hydrogen can be released from the mixture sample (B) at 90 W of microwave power. As will be noted from FIG. 9C, after the addition of graphite carbon as a thermal promoter, hydrogen was promptly released from sample (C).

### Example 14

Hydrogen Storage Particles: LiNH₂—LiH
Microwave Power: 70 W (pulse)
Sample (A)=thermal Promoter: graphite, 56 μm
Sample (B)=thermal Promoter: graphite, 150 μm
Sample (C)=thermal Promoter: graphite, 250 μm

The hydrogen storage particles (admixture of LiH and LiNH₂) and thermal promoter particles (graphite carbon) used in this example were prepared according to the same procedures of those in example 1. For samples (A), (B) and (C), the thermal promoter was 20 wt % graphite carbon (C) with respective particle sizes 56 μm C, 150 μm C and 250 μm C.

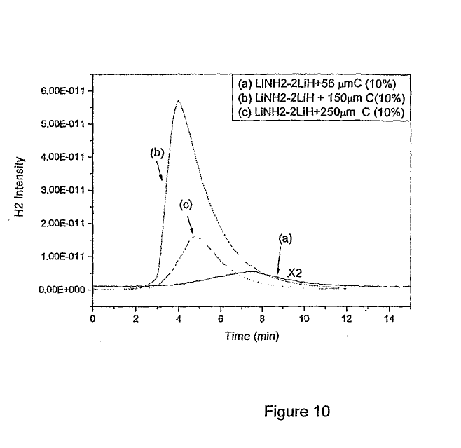

The release of hydrogen was recorded by mass spectrometer (10) of FIG. 1 and the results can be seen in FIG. 10. It will be noted from FIG. 10 the particle size of graphite carbon has a significant effect on the hydrogen released over LiNH₂-2LiH under microwave irradiation conditions. Graphite particles with 150 μm show the best results. The hydrogen intensity decreased according to the order of 150 μm>250 μm>56 μm.

### COMPARATIVE EXAMPLES

### Comparative Example 1

Hydrogen Storage Particles: LiH, LiNH₂
Thermal Promoter: None
Microwave Power: 700 W (continuous)

The hydrogen storage particles (LiH and LiNH₂) used in this comparative example 1 are the same as those used in examples 1 and 2. The difference between comparative example 1 and examples 1 and 2 is that graphite carbon is not added to the admixture. Further, the microwave power used in this experiment is 10 times that used in examples 1 and 2, or at 700 W.

The results of this comparative example 1 are shown in FIG. 2C. As seen, no hydrogen gas was released. The mixture of LiH and LiNH₂ was inert to microwave radiation even though the microwave power was set to a value as high as 700 W. Therefore, it can be seen that the use of graphite carbon as thermal promoter particles aided in the release of hydrogen from hydrogen storage particles.

### Comparative Example 2

Hydrogen Storage Particles: LiAlH₄
Thermal Promoter: None
Microwave Power: 450 W (continuous)

The hydrogen storage particles (LiAlH₄) used in this comparative example 1 are the same as those used in examples 3 to 5. The difference between comparative example 2 and examples 3 to 5 is that graphite carbon is not added to the admixture. Further, the microwave power used in this experiment is 9 times that used in examples 1 and 2, or at 450 W.

The results of this comparative example 2 are shown in FIG. 3D. As seen, no hydrogen gas was released. The LiAlH₄ particles were inert to microwave radiation even though the microwave power was set to a value as high as 450 W. Therefore, it can be seen that the use of graphite carbon as thermal promoter particles aided in the release of hydrogen from hydrogen storage particles such as LiAlH₄.

### Comparative Example 3

Hydrogen Storage Particles: MgH₂
Thermal Promoter: None
Microwave Power: 1000 W (continuous)

The hydrogen storage particles (MgH₂) used in this comparative example 3 are the same as those used in examples 6 to 8. The difference between comparative example 3 and examples 6 to 8 is that graphite carbon is not added to the admixture. Further, the microwave power used in this experiment is about 20 times that used in examples 6 and 7, or at 1000 W.

The results of this comparative example 3 are shown in FIG. 4D. As seen, no hydrogen gas was released. The MgH₂ particles were inert to microwave radiation even though the microwave power was set to a value as high as 1000 W. Therefore, it can be seen that the use of graphite carbon as thermal promoter particles aided in the release of hydrogen from hydrogen storage particles such as MgH₂.

### Comparative Example 4

Hydrogen Storage Particles: MgH₂
Thermal Promoter: None
Tube Furnace Power: 500 W (continuous)

MgH₂ particles were obtained and prepared as disclosed in Example 6.

0.5 g of MgH₂ was loaded into a fix bed stainless steel tube reactor with 5 mm inner diameter and 300 mm length. The reactor was then placed into a tube furnace (Elite). The tube furnace was controlled by a power transmitter which can be adjusted for different power output. The temperature was recorded by a thermal meter with K type thermocouple. Purified Ar gas was controlled by a mass flow meter with 50 ml/min flow rate and used as a carrier gas. The outlet gas was connected to a mass spectrometer (Omnistar) for analysis.

A tube furnace was used as a heating device. The tube furnace was equipped with heating elements surrounding a ceramic tube that was usually about 250 mm in length and 20 mm in diameter. The stainless steel tube reactor was placed into the tube furnace and the tube furnace was set to 500 W for about 33 minutes.

The results of this example are shown in FIG. 6b. As seen, the hydrogen gas was released after 17 minutes of heating. Therefore, it can be seen that the microwave method results in a more immediate release of hydrogen gas as compared to the tube furnace method even though the heating power of the tube furnace was set to 5 times the microwave power. The same amount of hydrogen gas was obtained as in Example 10.

### Comparative Example 5

Hydrogen Storage Particles: MgH₂
Thermal Promoter: None
Tube Furnace Power: 100 W (continuous)

The conditions for this experiment are the same as those in Comparative Example 4 with the exception that the microwave power is set at 100 W instead of 500 W. The reaction time for this experiment is 100 minutes.

The results of this example are shown in FIG. 6C. As seen, using a tube furnace with the same heating power as the microwave power of Example 10, the tube furnace method resulted in the release of hydrogen gas after a long period of time. The hydrogen gas started to be released after about 75 minutes of heating. The same amount of hydrogen gas was obtained as in Example 10.

The results shown in FIG. 6 demonstrate that microwave heating requires less power and results in more immediate release of hydrogen gas as compared to the tube furnace heating method.

Referring again to Table 3 above, the peak area indicates that similar amount of hydrogen gas is released and measured during the microwave method (Example 10) and the two tube furnace methods (Comparative Examples 4 and 5). The smaller energy input suggests that microwave heating method is about 5 to 6 times more efficient than the tube furnace heating.

### Comparative Example 6

Hydrogen Storage Particles: LiH, LiNH₂
Thermal Promoter: None
Tube Furnace Power: 500 W (continuous)

LiH and LiNH₂ particles were obtained and prepared as disclosed in Example 11.

0.5 g of the mixture of LiNH2 and LiH was loaded into a fix bed stainless steel tube reactor with 5 mm inner diameter and 300 mm length. The reactor was then placed into a tube furnace (Elite). The tube furnace was controlled by a power transmitter which can be adjusted for different power output. The temperature was recorded by a thermal meter with K type thermocouple. Purified Ar gas was controlled by a mass flow meter with 50 ml/min flow rate and used as a carrier gas. The outlet gas was connected to a mass spectrometer (Omnistar) for analysis. The reaction time for this experiment is about 32 minutes.

The results of this example are shown in FIG. 7b. As seen, the hydrogen gas was released after about 13 minutes of heating. Therefore, it can be seen that the microwave method results in a more immediate release of hydrogen gas as compared to the tube furnace method even though the heating power of the tube furnace was set to 5 times the microwave power. The same amount of hydrogen gas was obtained as in Example 11.

### Comparative Example 7

Hydrogen Storage Particles: LiH, LiNH₂
Thermal Promoter: None
Tube Furnace Power: 100 W (continuous)

The conditions for this experiment are the same as those in Comparative Example 6 with the exception that the microwave power is set at 100 W instead of 500 W. The reaction time for this experiment is 200 minutes.

The results of this example are shown in FIG. 7. As seen, using a tube furnace with the same heating power as the microwave power of Example 11, the tube furnace method resulted in the release of hydrogen gas after a long period of time. The hydrogen gas started to be released after about 25 minutes of heating and a total of 115 minutes is required for the total release of hydrogen gas. The same amount of hydrogen gas was obtained as in Example 11.

The results shown in FIG. 7 demonstrate that microwave heating requires less power and results in more immediate release of hydrogen gas as compared to the tube furnace method.

Referring now to Table 4, the peak area indicates that similar amount of hydrogen gas is released and measured during the microwave method (Example 11) and the two tube furnace methods (Comparative Examples 6 and 7). The smaller energy input suggests that microwave heating method is about 8 to 9 times more efficient than the tube furnace heating.

### Applications

As discussed above, the use of thermal promoter particles in an admixture of hydrogen storage particles and thermal promoter particles may promote the release of hydrogen gas from the hydrogen storage particles under irradiation conditions.

The effective release of hydrogen gas from the hydrogen storage particles may depend upon a variety of factors and they include: type of microwave used, heating method used (whether continuous, pulse or ramp), microwave power used, distribution of microwave energy inside the system, type of container, type of hydrogen storage particles used, size of the thermal promoter particles, shape of the thermal promoter particles, distribution of the thermal promoter particles in the admixture, concentration of the thermal promoter particles as well as interaction degree of the thermal promoter particles with the hydrogen storage particles.

Advantageously, the use of thermal promoter particles to promote release of hydrogen gas under irradiation conditions may be more energy and cost effective than conventional methods of releasing hydrogen. Further, the dangers associated with the use of high pressures or extremely cold temperatures to store or release hydrogen may be substantially reduced, if not avoided altogether, as the disclosed process may be achieved at atmospheric pressures and ambient temperatures.

Advantageously, the space required by the hydrogen storage particles and thermal promoter particles is substantially less than that occupied by liquid hydrogen storage tanks or compressed hydrogen gas storage tanks.

Advantageously, the use of thermal promoter particles to promote release of hydrogen gas under irradiation conditions may be faster and may require a smaller amount of power as compared to conventional heating methods to release hydrogen.

Advantageously, the disclosed process may be used on hydrogen storage materials that require extreme conditions to release the hydrogen gas stored.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process for releasing hydrogen comprising the step of irradiating hydrogen storage particles dispersed among thermal promoter graphite particles using radiation in the microwave range to release said hydrogen from said hydrogen storage particles.

2. (canceled)

3. A process as claimed in claim 1, comprising the step of applying said microwaves at a power in the range of 30 W to 180 KW or 30 W to 1200 W.

4. A process as claimed in claim 1, comprising the step of applying said microwaves with a frequency is in the range of 0.3 GHz to 300 GHz.

5. A process as claimed in claim 1, comprising the step of applying said microwaves in at least one of an inert atmosphere, hydrogen atmosphere and under a partial vacuum.

6. A process as claimed in claim 1, wherein the weight percent of said thermal promoter particles relative to said hydrogen storage particles is 0.1 wt % to 75 wt %.

7. A process as claimed in claim 1, wherein said hydrogen storage particles is comprised of a material selected from the group consisting of metal hydrides, metal nitrides, metal amides, metal imides, metal alanates, metal boron hydrides, complex metal hydrides and complexes, mixtures and derivatives thereof.

8. A process as claimed in claim 6, wherein said metal is selected from the group consisting of Group IA, Group IIA and Group IIIA from the Periodic Table of Elements, and mixtures thereof.

9. A process as claimed in claim 7, wherein said hydrogen storage particles is selected from the group consisting of lithium imides, lithium amides, lithium nitrides, lithium boron hydride, lithium alanates, lithium hydrides, sodium imides, sodium amides, sodium nitrides, sodium boron hydride, sodium alanates, sodium hydrides, potassium hydrides, magnesium imides, magnesium amides, magnesium nitrides, magnesium alanates, magnesium hydrides and aluminum hydrides.

10. A process as claimed in claim 6, wherein the elements of said complex metal hydrides are selected from the group consisting of Group IA, Group IIA, Group IIIA, Group VIIIB, Group IIIB, Group IVB, Group VA and Group VB of the Periodic Table of Elements, and mixtures thereof.

11. A process as claimed in claim 9, wherein said complex metal hydrides is selected from the group consisting of magnesium-nickel-hydrides, calcium-nickel-hydrides, lanthanum-nickel-hydrides, sodium borohydrides, magnesium-iron-hydrides or magnesium-cobalt-hydrides, and mixtures thereof.

12. A process as claimed in claim 1, wherein the average particle size of said hydrogen storage particles is in the micrometer range.

13. A process as claimed in claim 11, wherein the average particle size of said hydrogen storage particles is less than 100 μm.

14. A process as claimed in claim 13, wherein the average particle size of said hydrogen storage particles is in the range of 0.1 μm to 100 μm.

15. A process as claimed in claim 1, further comprising secondary thermal promoter particles being comprised of at least one of silicon, phosphor, sulfur and a metal selected from the group consisting of Group IIIA, Group VIIIB, Group VIIB, Group VIB, Group IVB, Group IB and Group IIB of the Periodic Table of Elements, and mixtures thereof.

16. A process as claimed in claim 14, wherein said metal is selected from the group consisting of aluminium, copper, silver, gold, iron, nickel, cobalt, manganese, chromium, titanium, zinc and alloys and mixtures thereof.

17. (canceled)

18. A process as claimed in claim 1, wherein the average particle size of the thermal promoter particles is 0.1 μm to 5000 μm or 0.1 μm to 150 μm.

19. A process as claimed in claim 15, wherein the secondary thermal promoter particles comprise strips of aluminium foil having a length in the range of 1 mm to 20 mm, and a width in the range of 0.5 mm to 5 mm.

20. A hydrogen release system comprising:
an enclosed chamber;
a mixture of hydrogen storage particles and thermal promoter graphite particles disposed within said enclosed chamber; and
a microwave generator capable of irradiating the mixture within said enclosed chamber in the microwave range;
wherein in use, said microwave source irradiates said mixture in said microwave range to release hydrogen from said hydrogen storage particles into said chamber.

21. (canceled)

22. A vehicle comprising the hydrogen release system of claim 18.

23. A vehicle which utilizes the step of irradiating hydrogen storage particles dispersed among thermal promoter graphite particles using radiation in the microwave range to release hydrogen from said hydrogen storage particles, for use as a fuel in said vehicle.

24. Use of thermal promoter graphite particles in admixture with hydrogen storage particles to promote release of hydrogen while said hydrogen storage particles are being irradiated using radiation in the microwave range.

25. A kit of parts for releasing hydrogen, the kit comprising:
hydrogen storage particles;
thermal promoter graphite particles; and
instructions for irradiating a mixture of said hydrogen storage particles and said thermal promoter particles using radiation in the microwave range while resident within an enclosed chamber to release hydrogen from said hydrogen storage particles.

26. A kit as claimed in claim 22, further comprising the enclosed chamber.

27. A kit as claimed in claim 22, further comprising an irradiation source capable of irradiation in the microwave range.

28. (canceled)
